(19) United States
(12) Patent Application Publication
(10) Pub. No.: US 2019/0189159 A1
(43) Pub. Date: Jun. 20, 2019

(54) VEHICLE ANNOTATION

(71) Applicant: MOTOROLA SOLUTIONS, INC, Chicago, IL (US)

(72) Inventors: GUO DONG GAN, KUALA LUMPUR (MY); CHUN MENG TAN, BAYAN LEPAS (MY)

(21) Appl. No.: 15/844,721

(22) Filed: Dec. 18, 2017

(51) Int. Cl. G11B 27/02; G06K 9/00; G06F 17/30

(52) U.S. Cl. CPC G11B 27/02; G06F 17/3056; G06K 9/00791

(57) ABSTRACT

A method and apparatus for annotating video is provided herein. During annotation of a video, important objects are identified, and annotations are placed on top of objects/subjects in the video that are not identified as important to a particular incident type. With this technique, annotations can be implemented without blocking objects/subjects deemed important for a particular incident type.

### BACKGROUND OF THE INVENTION

Annotations on video can help viewers identify important elements within a video. Unfortunately, annotations may be placed over other important elements of a video, blocking the user's view of these elements. Past techniques have attempted to solve this issue by placing annotations on predefined regions or regions that are bound by unchanged pixels. However, even this technique does not always prevent annotations from blocking important elements within a video. Therefore, a need exists for video annotation that greatly reduces the amount of annotation placed over important elements within a video.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrated a general operating environment of the present invention.

FIG. 2 illustrated a general operating environment of the present invention.

FIG. 3 is a block diagram of a device for annotating images/video.

FIG. 4 is a flow chart showing operation of the device of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for annotating video is provided herein. During annotation of a video, important objects are identified, and annotations are placed on top of objects/subjects in the video that are not identified as important to a particular incident type. With this technique, annotations can be implemented without blocking objects/subjects deemed important for a particular incident type.

In order to determine those objects that should be identified as important, a database is accessed that contains a list of important objects that are related to a particular incident type. For example, for an incident type identified as a “police chase”, objects such as automobiles, license plates, road signs, . . . , etc. may be identified as important objects. However, for an incident type identified as “stray dog” road signs and license plates may not be identified as important.

In one embodiment of the present invention, a computer-aided dispatch (CAD) incident identifier is utilized to determine important objects. An incident identification (sometimes referred to as an incident scene identifier, or a CAD incident identifier) is generated for incidents where an officer is dispatched, and uniquely identifies public-safety events. This ID could be something as simple as a number, or something as complicated as an identification that is a function of populated fields, one of which may comprise an incident type.

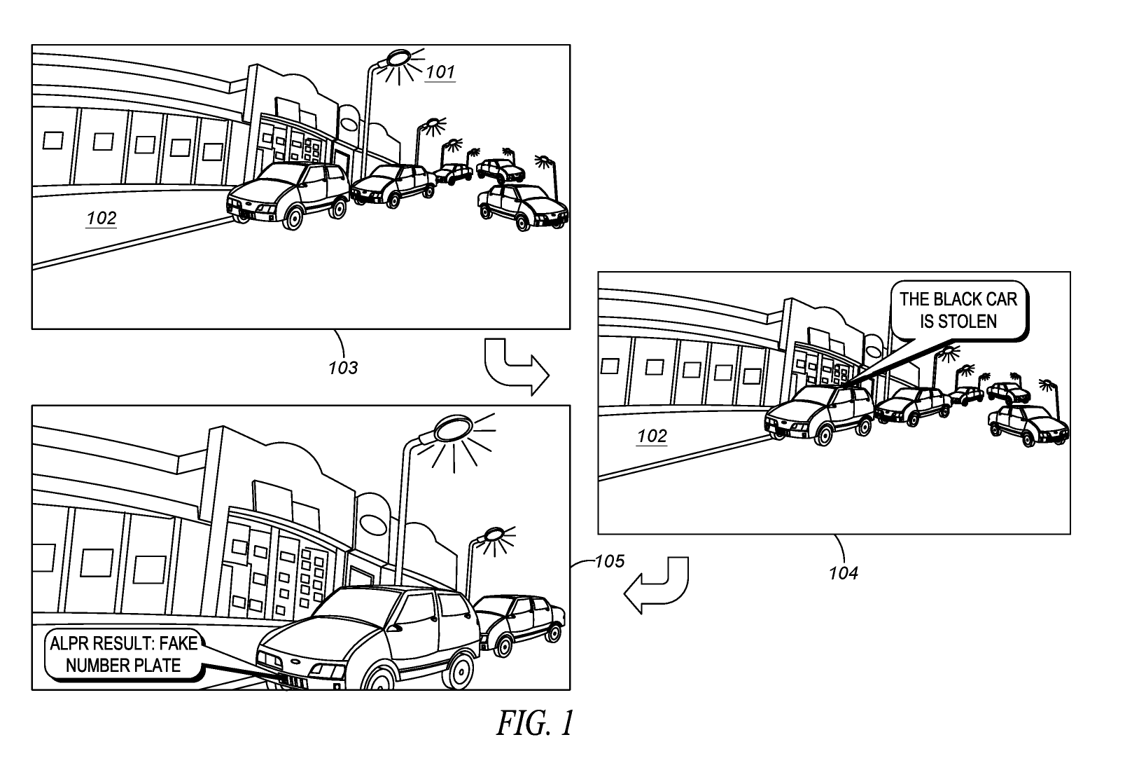

Expanding on the above, an object to be annotated is identified, and important items are identified based on the incident identifier. The object is then annotated with the annotation placed over other objects that have not been identified as important. (It should be noted that in this context “incident identifier” refers to a public-safety incident identifier, such as, but not limited to any type of crime, traffic accidents, weather phenomenon, fire, . . . , etc.). This is illustrated in FIG. 1.

As shown in FIG. 1, a first annotation “This car is stolen” is to be placed in image/video 103 and attached to a particular vehicle. A public-safety incident ID corresponding to a stolen vehicle is associated with the image/video, and important objects (e.g., the car and the license plate) are determined based on the incident ID. In this case lamp 101 and curb 102 has not been identified as important, and the annotation is placed on lamp 101 (image/video 104). Similarly, in image/video 105 (which may simply be another scene of video 103/104) an annotation “ALPR result: Fake Number Plate” is to be attached to a car license plate. Since curb 102 has not been identified as important, the annotation is then placed on curb 102.

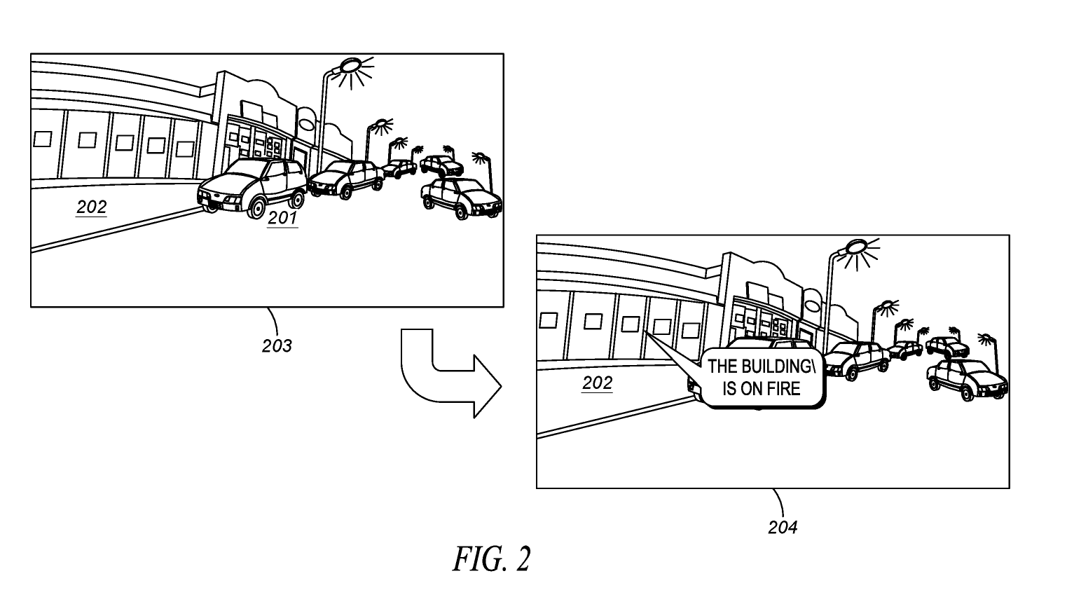

Consider the same scene in FIG. 2. A public-safety incident ID corresponding to a building on fire is associated with the same image/video, and important objects (e.g., the building and any bright object) are determined based on the incident ID. As shown in FIG. 2, a first annotation “This building is on fire” is to be placed in image/video 203 and attached to a particular building. A public-safety incident ID corresponding to a fire is associated with the image/video, and important objects (e.g., the building and bright objects) are determined based on the incident ID. In this case car 201 and curb 202 has not been identified as important, and the annotation is placed on car 201 (image/video 204).

As is evident, in the same image/video, annotations can be place over different objects, solely based on the incident identification associated with the image/video at the time the annotation is being placed. Therefore, a first image associated with a first incident ID may have an annotation placed over a first object, and have a second object identified as important (no annotation to be placed over the second object). However, if the first image is associated with a second incident ID, the first image may have the annotation placed over the second object, and have the first object identified as important (no annotation to be placed over the first object).

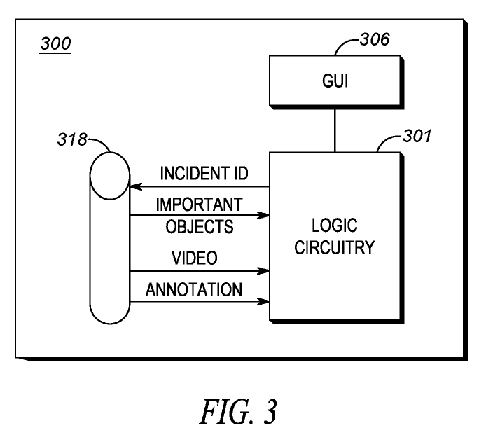

FIG. 3 is a block diagram of apparatus 300 for annotating video. As shown, apparatus 300 comprises microprocessor (logic circuitry) 301, Graphical User Interface (GUI) 306, and storage 318. GUI 306 provides a man/machine interface for receiving an input from a user and displaying information. For example, GUI 306 may provide a way of conveying (e.g., displaying) information received from processor 301. Part of this information may comprise modified search results. In order to provide the above features (and additional features), GUI 306 may comprise any combination of a touch screen, a computer screen, a keyboard, or any other interface needed to receive a user input and provide information to the user.

Logic circuitry 301 comprises a digital signal processor (DSP), general purpose microprocessor, a programmable logic device, or application specific integrated circuit (ASIC) and is configured to serve to annotate video (which may be stored in storage 318 or received elsewhere) as described above. In order to determine objects within any video/image, logic circuitry 301 serves as a video analysis engine (VAE) which comprises a software engine that analyzes analog and/or digital video. The engine is able to “watch” video and detect pre-selected objects. The VAE may contain any of several object detectors. Each object detector “watches” the video for a particular type of object. Object detectors can be mixed and matched depending upon what is trying to be detected. For example, an automobile object detector may be utilized to detect automobiles, while a fire detector may be utilized to detect fires. On detecting a particular object, the VAE may identify the object as important based on an incident identification.

Database 318 comprises standard memory (such as RAM, ROM, . . . , etc.) and serves to store incident IDs, important objects, video, and annotation for particular video.

During operation a user instructs logic circuitry 301 via GUI 306. The user may view a video and generate annotation, or the annotation may be generated automatically. For example, a user may tag a license plate within a particular video and instruct annotation “fraudulent license plate” to be associated with the tagged plate. Regardless of how the annotation is generated, the video and annotation are associated and stored within storage 318. When a user provides logic circuitry 301 with an incident identification, and instructs playback of the video/annotation, logic circuitry 301 accesses database and determines important objects and places any annotation as discussed above.

Expanding on the above, a user may wish to attach annotation to an object or annotation may be generated automatically. Regardless, annotation may be placed into any video by logic circuitry 301, and attached to a particular object. However, the annotation will be placed so that it does not block an object of interest.

It should be noted that annotation does not need to be “attached” to an object at all. For example, a video scene may be annotated with “suspect to appear from the left in 5 seconds”. This annotation may simply be placed in an image/video and not associated with any object. However, as described above, the annotation will be placed in the video such that it does not block an object of interest.

Table 1 shows an example of a mapping of incident identification and objects of interest. The mapping process preferably comprises an operation that associates each element of a given set (the domain) with one or more elements of a second set (the range). The incident identification (potentially a CAD ID) comprises the domain, while the important objects comprises the range. The mapping may be explicit based on predefined rules (prepopulated data), or the mapping may be trained via neural network modeling. Hence, the table may be generated and stored within storage 318.

TABLE 1
mapping between incident ID and important objects

| CAD ID (incident) | Important Objects |
|---|---|
| 0010 (stray animal) | Animals, Humans |
| 0020 (police chase) | Automobiles, license plates |
| 0030 (fire) | buildings, humans, fire |
| . . . | . . . |
| 00xx (vehicle accident) | intersections, road signs, vehicles |

With the above in mind, apparatus 300 comprises a database (e.g., Table 1) comprising a plurality of incident identifiers that identify incident types, the database also comprising objects of interest associated with the incident types. Apparatus 300 also comprises video analysis engine 301 configured to determine an incident type, determine an annotation, access the database to determine objects of interest associated with the incident type, access a video, identify the objects of interest associated with the incident type within the video, and place the annotation within the video such that the annotation does not block an object of interest associated with the incident type.

As discussed above, the incident type may received from a user via graphical user interface 306. Also, the incident type may comprise a public-safety computer-aided dispatch (CAD) incident identification.

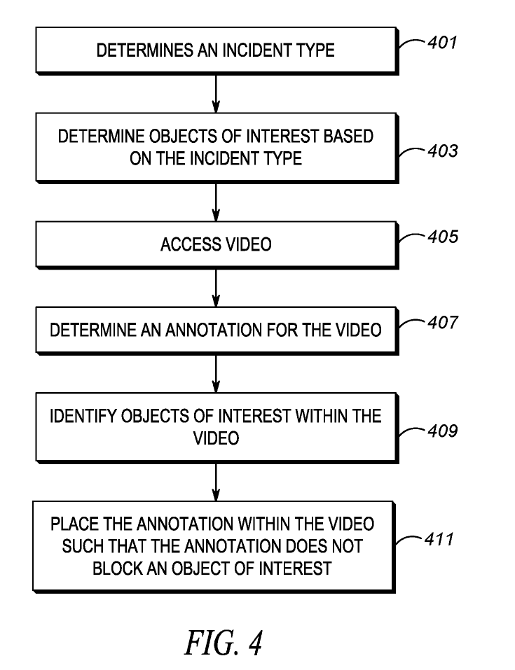

FIG. 4 is a flow chart showing operation of apparatus 300. The logic flow begins at step 401 where logic circuitry 301 determines a first incident type. As discussed above, the incident type may be received from GUI 306. At step 403 a database is accessed to determine first objects of interest based on the first incident type. At step 405 a video is accessed. As discussed above, the video may be stored on storage 318 and accessed from storage 318.

Logic circuitry 301 then determines an annotation for the video (step 407). The annotation may be included within metadata associated with the video, with the metadata being stored in storage 318. Alternatively, the annotation may be provided in “real time” by a user via GUI 306. Regardless of how the annotation is obtained, at step 409, logic circuitry 301 identifies objects of interest within the video and places the annotation within the video such that the annotation does not block an object of interest included within the objects of interest (step 411). So for example, if the incident identifier is 0030, then from Table 1 above, any annotation will not block buildings, humans, and fire.

As discussed, the incident type may be received from a user via a graphical user interface. Also, the incident type may comprise a public-safety computer-aided dispatch (CAD) incident identification.

As discussed above, if a second incident type is received, logic circuitry 301 will access the database to determine second objects of interest based on the second incident type, identify the second objects of interest within the video, and place the annotation within the video such that the annotation does not block an object of interest included within the second objects of interest.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus comprising:
a database comprising a plurality of incident identifiers that identify incident types, the database also comprising objects of interest associated with the incident types;
a video analysis engine configured to:
determine an incident type;
access the database to determine objects of interest associated with the incident type;
access a video;
determine an annotation;
identify the objects of interest associated with the incident type within the video; and
place the annotation within the video such that the annotation does not block an object of interest associated with the incident type.

2. The apparatus of claim 1 wherein the incident type is received from a user via a graphical user interface.

3. The apparatus of claim 1 wherein the incident type comprises a public-safety computer-aided dispatch (CAD) incident identification.

4. The apparatus of claim 1 wherein the incident type is received from a user via a graphical user interface and wherein the incident type comprises a public-safety computer-aided dispatch (CAD) incident identification.

5. A method comprising the steps of:
determining a first incident type;
accessing a database to determine first objects of interest based on the first incident type;
accessing a video;
determining an annotation;
identifying the first objects of interest within the video; and
placing the annotation within the video such that the annotation does not block an object of interest included within the first objects of interest.

6. The method of claim 5 wherein the first incident type is received from a user via a graphical user interface.

7. The method of claim 5 wherein the first incident type comprises a public-safety computer-aided dispatch (CAD) incident identification.

8. The method of claim 5 wherein the first incident type is received from a user via a graphical user interface and wherein the first incident type comprises a public-safety computer-aided dispatch (CAD) incident identification.

9. The method of claim 5 further comprising the steps of:
determining a second incident type;
accessing the database to determine second objects of interest based on the second incident type; and
identifying the second objects of interest within the video; and
placing the annotation within the video such that the annotation does not block an object of interest included within the second objects of interest.
